(19) United States
(12) Patent Application Publication
(10) Pub. No.: US 2019/0242363 A1
(43) Pub. Date: Aug. 8, 2019

(54) TRANSLATIONALLY MOVABLE WIND POWER PLANT

(71) Applicant: Jan Franck, Weidenberg (DE)

(72) Inventor: Jan Franck, Weidenberg (DE)

(21) Appl. No.: 16/385,085

(22) Filed: Apr. 16, 2019

Related U.S. Application Data
(63) Continuation-in-part of application No. 15/504,860, filed on Feb. 17, 2017, now abandoned.

(30) Foreign Application Priority Data
Aug. 18, 2014 (DE) 10 2014 012 048.1

(51) Int. Cl. F03D 7/02; F03D 9/11; F03D 9/25

(52) U.S. Cl. CPC F03D 7/0204; F03D 9/25; F03D 9/11; F03D 7/026

(57) ABSTRACT

A wind generator, comprising: at least one wind wheel which is mounted to be rotatable around a rotational axis, and which has one or more blades or other wind-guiding surfaces for converting flow energy of wind into rotational energy, at least one generator, which is coupled to a hub or shaft of the wind wheel or to an output shaft of a gear connected thereto, for converting the rotational energy into electrical energy, wherein a center of gravity of the wind wheel, together with a hub and rotor shaft and rotatable parts which are coupled to the hub or rotor shaft and rotate around the same rotational axis, is translationally movable in a horizontal or approximately horizontal direction, characterized in that: the generator is either a direct current generator or is on its output side coupled to a rectifier to provide the electrical energy as direct current, and at least one energy storage is coupled to a direct current output of the generator or of the rectifier for receiving and storing the electrical energy.

### REFERENCE TO PENDING PRIOR PATENT APPLICATIONS

This patent application is a continuation-in-part of pending prior U.S. patent application Ser. No. 15/504,860, filed 17 Feb. 2017 by Jan Franck for WIND TURBINE WHICH CAN BE MOVED IN TRANSLATION, which patent application in turn is a 371 national stage entry of International (PCT) Patent Application No. PCT/162015/001384, filed 18 Aug. 2015 by Jan Franck for WIND TURBINE WHICH CAN BE MOVED IN TRANSLATION, which in turn claims benefit of German Patent Application No. DE 10 2014 012 048.1, filed 18 Aug. 2014.

The three (3) above-identified patent applications are hereby incorporated herein by reference.

### FIELD OF THE INVENTION

The invention is directed to a wind generator, comprising a wind turbine which is mounted so that it is rotatable about a horizontal or approximately horizontal rotational axis, and which has one or more blades or other wind-guiding surfaces for converting flow energy of the wind into rotational energy, and at least one generator, coupled to the hub or shaft of the wind turbine, for converting the rotational energy into electrical energy.

### BACKGROUND OF THE INVENTION

To supplement and to reduce consumption of existing fuels, ever since the so-called energy transition there has also been increasing use of renewable energies, in particular wind energy.

However, the wind flow in many areas is somewhat sporadic, and it is not uncommon for periods with high wind to be interspersed with calm or windless phases. In addition, during periods with low wind, the massive rotor of a wind power plant often cannot be set in motion, so that wind energy plants generally are able to deliver energy only at higher wind speeds.

### SUMMARY OF THE INVENTION

The disadvantages of the described prior art have resulted in the object of the invention, to design a wind generator such that the incident relative wind speed is, or can be made to be, as high as possible.

This object is achieved in that the center of gravity of the wind turbine, together with the hub and rotor shaft and rotatable parts coupled thereto which rotate about the same rotational axis, is translationally or predominantly translationally movable. Translational movement is understood in particular to mean any movement that is allowed by such bearing or guiding in which the parts in question are movable, at least locally, in a horizontal or approximately horizontal direction, in particular in the direction of the rotary shaft of the wind turbine. In other words, the path of the translational movement may extend along a curve, and does not have to be straight. As the result of such a degree of freedom of movement, on the one hand there is the possibility of being able to immediately give way to extremely high winds and thus reduce the relative flow velocity. On the other hand, for example after such gusts have subsided, by means of a resetting movement of the wind turbine the relative flow velocity may be increased again, thus increasing the energy output. Use is made of the option for the wind turbine to be translationally driven in order to virtually increase the incident wind speed. When the most favorable available drive energy possible is utilized for this purpose, electrical energy may be generated even when there is little or no wind flow. In this regard, other flow energies come into consideration as primary energy, for example water flow in a river (hydropower) or in coastal areas (tidal power), or vertical air flow (convection energy), optionally assisted by electrical energy or other fossil fuels, for example for purposes of start-up. However, as described in greater detail below, it is conceivable to also utilize wind energy as primary energy for the translational movement according to the invention.

For the purpose of storing the energy of the generator on board of the regarding vehicle, the generator should either be a direct current generator or should on its output side be coupled to a rectifier to provide the electrical energy as direct current, because a direct current energy can be stored rather easily, compared to an alternating current energy.

For receiving and storing the electrical energy, at least one energy storage should be coupled to a direct current output of the generator or of the rectifier.

Like the wind wheel, the at least one energy storage is translationally movable in a horizontal or approximately horizontal direction. Especially, the at least one energy storage should be mounted in such way that a center of gravity of the energy storage is translationally movable in the same direction and with the same speed as the center of gravity of the wind wheel.

In order to hold the energy over a long period, if necessary, it is recommended that the at least one energy storage is a static storage for storing the fed electrical energy permanently.

A first embodiment of the invention is characterized in that the at least one energy storage comprises at least one capacitor for storing the fed electrical energy electrically, especially in the form of an electrical field. In such capacitors, the stored voltage can be substantially higher than the voltage of a battery, for example.

At another embodiment, it is provided that the at least one energy storage comprises at least one accumulator for storing the fed electrical energy electro-chemically. The advantage of an accumulator over a capacitor is the possibility to store the energy over days, weeks or months.

It is preferred that the at least one energy storage comprises at least one lithium ion accumulator.

The at least one energy storage comprises at least one apparatus for storing the fed electrical energy chemically, especially in the form of a chemical gas, liquid oder substance.

At least one apparatus for converting the fed electrical energy into a chemical gas, liquid oder substance comprises at least one electrolytic cell, especially an electrolytic cell for the fission of water, especially distilled water, into oxygen and hydrogen. Hydrogen is an element which can unite with oxygen to water, according to the following formula:

2H₂+O₂→2H₂O.

As oxygen can be found in the atmosphere in a sufficient amount, only the hydrogen has to be stored.

At least one apparatus for storing the fed electrical energy chemically comprises at least one storage tank for storing the electrolytically generated hydrogen. Such a storage tank—even if it is filled up to a pressure of about 200 bar, for example—has substantially less weight than an accumulator, where the same amount of energy is stored.

A rectifier—if necessary—should be a bridge rectifier, because then no energy is lost by the conversion from alternate current to direct current.

It has been found to be advantageous for the translational movement of the wind generator to take place guided in parallel to the surface area of a subsurface, in particular guided in parallel to a preferably horizontal plane. Since the wind almost always blows predominantly horizontally, it may thus be ensured that the prevailing wind direction and the translational movement lie within the same plane, for example approximately within a horizontal plane.

In addition, the wind resistance of the wind turbine or of parts thereof may be adjustable, in particular in that the setting angle of one or more blades or other wind-guiding surfaces is changeable, or in that the wind turbine is pivotable with respect to the incident flow direction, or in that a preferably streamlined cowling is pivotable in front of the wind turbine. The conversion of wind energy into rotational energy can be controlled in this way. In this regard, the measures, listed by way of example, for influencing the wind resistance have different effects on the degree of conversion:

If the blades or other wind-guiding surfaces are preferentially set transversely with respect to the wind direction, the wind resistance and also the degree of conversion of wind energy into rotational energy increase; if these blades or wind-guiding surfaces are preferentially set in parallel to the wind direction, the wind resistance and also the degree of conversion of wind energy into rotational energy decrease.

If the rotational axis of the wind turbine is set at a preferably steep angle against the wind direction, in the ideal case antiparallel to the wind direction, the wind resistance and also the degree of conversion of wind energy into rotational energy increase; if the wind turbine is turned away from the wind, i.e., the intermediate angle between the wind direction and the rotational axis of the wind turbine is increased, the wind resistance and at the same time also the degree of conversion of wind energy into rotational energy decrease.

Lastly, if a streamlined cowling is pivoted in front of the wind turbine, on the one hand the wind resistance increases, and on the other hand the energy output, i.e., the degree of conversion of wind energy into rotational energy, decreases.

From this it is known that, depending on the measure, the change ratio between the wind resistance and the energy output may be in the same direction; i.e., with increasing wind resistance the energy output also increases, but may also be in opposite directions; i.e., with increasing wind resistance the energy output decreases.

The invention may be implemented, for example, by the wind generator having a mobile design, in particular by means of wheels on the bottom. It is thus possible to move a wind turbine as necessary, and to thus generate a velocity with respect to the surrounding air which allows the rotor to start/run and generate power.

It has proven to be advantageous for the wind generator to be situated onboard a vehicle. This may be a preferably motorized road vehicle or a rail vehicle.

The invention may be refined in that the vehicle can travel on rails. In such cases, a translational movement in the direction of the rails is possible, but another movement transverse thereto is not.

Furthermore, the teaching of the invention provides that the rails are laid in a circle. A vehicle or chassis guided thereon can thus travel in both directions for an unlimited period of time.

It is within the scope of the invention that the rails are mounted on a tower or some other elevated structure. The wind turbine is thus situated at a higher level than the surrounding terrain, where higher wind speeds naturally prevail, so that an increased energy output is achievable.

The wind generator and/or its wind turbine should not be coupled in terms of rotational movement to one of the bottom-side wheels. In other words, the rotational energy of the wind turbine should not, or should not directly, be transmitted to the bottom-side wheels, since in such cases the efficiency of the system would be reduced.

The invention may be refined by eccentrically mounting the nacelle so that it is rotatable or pivotable about a vertical pivot axis. For such a nacelle that is guided above the ground surface, the rails laid along the circumference of a circle are replaced by a central bearing about a vertical pivot axis.

In the invention it is recommended that the nacelle is eccentrically mounted so that it is pivotable in a circle about a vertical pivot axis, the rotational axis of the wind turbine being oriented approximately tangentially with respect to the circle described by the nacelle. In such cases, there is a maximum coupling between the incident wind energy and the rotational energy converted therefrom.

The vehicle or chassis or the nacelle is preferably provided with or coupled to a device, in particular a motor, for translationally driving same. An actively influenceable power flow to/from a motor provides the option of controlling or even regulating the translational movement corresponding to certain requirements.

The drive device may be designed as an internal combustion engine, as an electric motor, or as a propeller that is mounted so that it is rotatable about a vertical axis, and driven by a preferably upwardly directed convection flow. The type of motor depends on the type of primary energy used. The motor may be coupled in various ways in order to set the wind energy plant in translational movement. On the one hand, the bottom-side wheels of a vehicle or chassis may be driven directly by the motor, from which the translational movement of the vehicle or chassis is indirectly derived. On the other hand, the motor may be connected or coupled to the undercarriage of the vehicle or the chassis in order to drive it forward. On the one hand, a bracket or boom which connects a centrally situated motor to the vehicle or chassis that is movable along a circumferential periphery is conceivable; on the other hand, the coupling between the motor and the vehicle or chassis could also be established via a traction means, for example a cable, which extends along the length of the vehicle or chassis.

Preferably, a useful electric motor comprises at least one three-phase synchronous or asynchronous motor.

If the energy is stored in the form of a direct current, whereas a synchronous or asynchronous motor is used, at least one three-phase inverter should be interconnected between the electric output of the at least one energy storage and a three-phase synchronous or asynchronous motor, to provide the motor with a compatible form of energy.

A three-phase output of the at least one three-phase inverter may be switchable to an output connector for exchanging electric energy between the energy storage and an external energy grid.

An optimum function can be achieved by a control device for switching the three-phase output of the at least one three-phase inverter either to an at least one three-phase synchronous or asynchronous motor, or to an alternating current output of the generator, or to an output connector for exchanging electric energy between the energy storage and an external energy grid. In such case, a single inverter can be used for several purposes.

An electric input and an electric output of a capacitor or accumulator can be conductively connected to each other, so that energy can flow in different directions dependent of the actual needs.

At least one storage tank for storing electrolytically generated hydrogen comprises an outlet duct which is coupled to a fuel cell.

The purpose of the fuel cell is to transform chemically stored energy of electrolytically generated hydrogen into electrical energy.

Preferably, the fuel cell comprises an electric output where direct current is provided.

Further advantages result from the fact that the projection of the center of gravity of the device, in particular the motor, for driving the chassis or vehicle or the nacelle is situated within a circle described by the vehicle or chassis or the nacelle during its movement, preferably at or near the midpoint of the circle. The motor could be situated onboard the vehicle or chassis; however, in such an arrangement the motor is preferably stationary, and thus does not move with the vehicle and instead is only coupled thereto. Due to its central position, the motor does not have to follow the vehicle or chassis or the nacelle, and instead remains coupled thereto via traction, thrust, or swivel means.

One preferred arrangement is characterized in that the projection of the center of gravity of the device, in particular the motor, for driving the vehicle is situated on the subsurface guiding the vehicle, outside a polygon spanned by the contact areas of the bottom-side wheels on the subsurface, which may implemented, for example, by the drive means being situated not onboard the vehicle, but instead at an external location.

On the other hand, the projection of the center of gravity of the wind turbine or wind generator onto the subsurface guiding the vehicle should be situated within a polygon spanned by the contact areas of the bottom-side wheels on the subsurface. In other words, the wind turbine is mounted onboard the vehicle or chassis, and for reasons of maximum stability a symmetrical weight distribution is sought, the wind turbine or the entire wind generator being situated preferably centrally on the vehicle or chassis.

In order to always be able to capture maximum incident air at any orientation of the wind turbine, a wind turbine according to the invention should not be situated within a wind tunnel or surrounded by wind deflector plates. In addition, a wind tunnel or the like could provide an increased wind exposure area in the event of an angled incident wind flow, thus entailing the risk of instability.

The diameter of the wind turbine should be greater than the largest width of the vehicle or chassis, in particular greater than the lateral distance between two bottom-side wheels thereof on different sides of the vehicle or chassis. In this way, maximum wind energy may be captured and converted into rotational energy.

Multiple chassis or nacelles may be guided at the same time on a guide device, i.e., on rails or on a vertical pivot axis. The efficiency of the system may be further increased in this way, since the energy output generally is approximately proportional to the number of wind turbines or wind generators.

The invention further provides that multiple chassis or nacelles guided on the same guide device are connected or coupled to one another in order to undergo synchronous movements. Such a connection on the one hand results in synchronicity of the movements, only with a phase shift, and on the other hand provides the option of being able to transmit forces between the various chassis or nacelles, in particular also drive forces for the translational movement according to the invention.

The sides of the wind turbines to be acted on by incident wind flow on multiple chassis or nacelles may point in the local directions corresponding to the same movement direction of the connecting means. In other words, these local directions are in each case situated, for example, on the front side, viewed in the movement direction. For circular guiding, i.e., with rails laid in a circle or with a central pivot axis, the wind turbines in question are then in each case situated, for example, at the front in the clockwise direction, or alternatively, in each case at the rear in the clockwise direction. For a joint circulation under calm conditions, all wind turbines then experience approximately equal incident flow; in contrast, when there is wind flow, with two wind turbines one wind turbine is always driven by the wind, while the other is at the same time decelerated.

On the other hand, there is also an arrangement in which the sides of the wind turbines to be acted on by incident wind flow on multiple chassis or nacelles point in the local directions corresponding to opposite movement directions of the connecting means. This would result in a circulation position in which both wind turbines face the incident air of the wind, and are thus set in rotation by same.

The invention may be refined in that the blades of a wind turbine are adjustable about their longitudinal axes in order to be adaptable to different relative speeds of the incident air. This function is primarily advantageous for wind when the wind turbine translationally moves along an arched curve, and the relative incident flow velocity of the air accordingly changes.

When the blades of a wind turbine are continuously adjustable, i.e., adjustable over arbitrary, unlimited setting angles, an adaptation may also be made to a reversal of the direction of relative rotation with respect to the incident air.

When multiple wind turbines are coupled to one another in terms of movement and connected to one another for force transmission, regulation may be implemented which always orients multiple, preferably two, mutually connected wind turbines against the wind, in that the setting angle of the blades of the front wind turbine in the particular incident flow direction is in each case adjusted in such a way that the wind resistance of this wind turbine is increased, and is thus reduced by the incident wind. Since only minimal energy is required for adjusting the setting angles of the blades, the efficiency of the system may thus be improved; the actual energy for orienting the wind turbines is supplied by the wind itself.

A wind energy plant according to the invention preferably includes a device for feeding the obtained electrical energy as current into a power grid, in particular an alternating current power grid or three-phase power grid. For transmitting higher levels of power, it is essential that the wind energy plant according to the invention is connected to the power grid by a cable, at least by a two-wire cable in the case of alternating current power delivery, or at least by a three-wire cable in the case of three-phase current power delivery. For circulating arrangements, it may be necessary to transport the current from a wind generator to a stationary connecting cable via slip rings.

In Central Europe, public three-phase power grids and alternating current power grids as a part of same are operated at a frequency of 50 Hz, whereas other countries such as the United States operate at 60 Hz. In any case, a device for synchronizing the current, to be fed, with the frequency of the voltage in the alternating current power grid or three-phase power grid is necessary. For this purpose, the current generated in a wind generator is typically transformed by an inverter or a converter to the frequency in question, and then injected into the grid, against the grid voltage. For this purpose, the grid voltage is customarily sampled, and on this basis the desired phase position of the current, and then also its amplitude, are computed, and the inverter or converter is then appropriately controlled, which takes place by suitable clocking of the current valves.

According to the invention, it may be further provided that a freewheel is situated between a wind turbine and the electric generator associated therewith, so that in the event of a countergust, the electric generator, despite the decelerated wind turbine, can continue to rotate freely in a practically undecelerated manner. In such cases, no energy is withdrawn from the rotating generator due to a countergust, thus further optimizing the efficiency.

Furthermore, a device for deflecting countergusts or other types of air flow that are unfavorable for the normal rotational direction of the wind turbine may be provided at the wind turbine, preferably upstream or downstream therefrom. For example, a circulating wind turbine may be acted on with incident flow from behind instead of from the front, as is customary, during its return. This reversed incident flow direction would decelerate the wind turbine, and therefore such an uncommon wind incident flow should be kept away from the wind turbine during a return. This may be achieved by deflecting this flow.

Lastly, according to the teaching of the invention, the device for deflecting countergusts or other types of air flow that are unfavorable for the normal rotational direction of the wind turbine is designed as a lamella-like curtain whose lamellae are open for a normal incident flow direction of the air, but closed for the opposite incident flow direction of the air.

It is conceivable to provide a plurality of mutually parallel lamellae, each having a horizontal longitudinal axis. Each lamella is mounted so that it is pivotable about one of its longitudinal edges, in particular about the top longitudinal edge in each case, for example in a lateral mounting. Under usual flow conditions, the lamellae are controlled by the wind to assume an approximately horizontal position, so that the interspaces between the lamellae are open and the wind can flow essentially unhindered up to the wind turbine in order to drive it in the usual rotational direction. Under “unusual” flow conditions, however, the lamellae fall into an approximately vertical plane; however, due to stop elements at that location the lamellae are not able to pivot further, and instead remain in this plane and therefore jointly close the entire incident flow area, i.e., keep the unfavorable wind away from the wind turbine. The wind turbine therefore is not decelerated. In addition, the back-pressure of the wind which now acts on the lamellae may be used as a translational drive until the wind turbine in question, which is translationally accelerated in this way, once again reaches an area with typical wind conditions, and can then draw rotational energy from same, which is ultimately converted into electrical energy.

At a special embodiment, the rotational axis of the at least one wind wheel extends in a vertical direction.

A wind wheel with a vertical axis of rotation converts flow energy of wind into rotational energy independent of the flow direction of the wind. Therefore, such embodiment can generate energy even if the vehicle is not moving, if a wind strength is sufficient.

On the other hand, an at least one wind wheel with a vertical axis of rotation is designed to convert flow energy of the air stream of the translational moving wind generator into rotational energy independent of the translational moving direction of the wind generator. Therefore, the direction of movement must neither be parallel to the wind direction nor antiparallel to that.

It is preferred that the at least one wind wheel is designed to transport people and/or goods. Therefore, suitable vehicles are motor cars, buses and motor vans.

### BRIEF DESCRIPTION OF THE DRAWINGS

Further features, particulars, advantages, and effects based on the invention result from the following description of one preferred embodiment of the invention, with reference to the drawings, which show the following:

FIG. 1 shows a wind power plant having a wind turbine and wind generator that are movable on rails;

FIG. 2 shows another wind power plant having two wind turbines that are movable on rails, together with one wind generator each, with automatic regulation of the azimuthal orientation against the wind being implemented;

FIG. 3 shows another modified wind power plant having two wind turbines that are movable on rails, together with one wind generator each, the wind turbines being provided with variable flow panels in order to keep unfavorable flow conditions away from the wind turbine in question;

FIG. 4 shows further details of the wind power plant of FIG. 1;

FIG. 5 shows a side elevation of a wind power plant having a wind wheel rotating around a horizontal axis coupled to a generator, which both elements are movable without rails;

FIG. 6 shows another embodiment with a wind wheel rotating around a vertical axis in a perspective similar to FIG. 5;

FIG. 7 shows the wind wheel of the embodiment according to FIG. 6 in a perspective view;

FIG. 8 shows a block circuit diagram with relevant mechanic and electric components, which is compatible to all aforementioned embodiments; and

FIG. 9 shows another block circuit diagram of the relevant mechanic and electric components of a wind turbine according to any of the aforementioned embodiments.

### DETAILED DESCRIPTION OF THE PREFERRED EMBODIMENTS

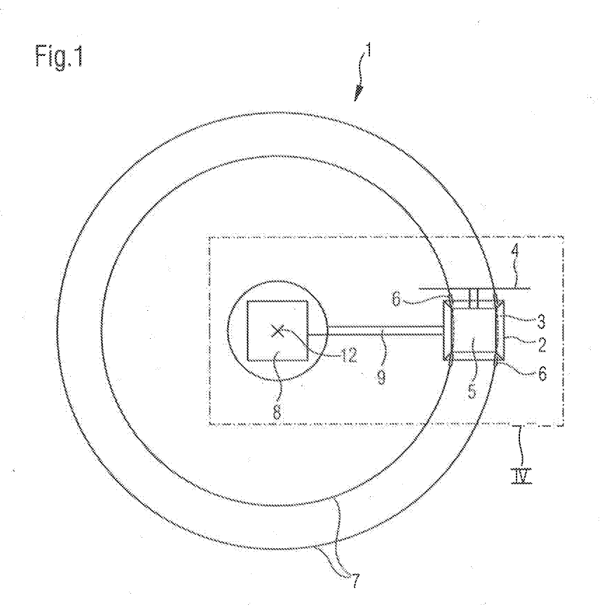

The mobile wind power plant 1 according to the invention according to FIG. 1 comprises a chassis 2 with a framework 3 for a wind turbine 4, and an electric generator 5 that is coupled thereto, for example via a gear.

Wheels 6 having wheel rims that are movable on rails 7 are mounted on the chassis 2. The wind power plant 1 may be moved along the rails 7 in this way.

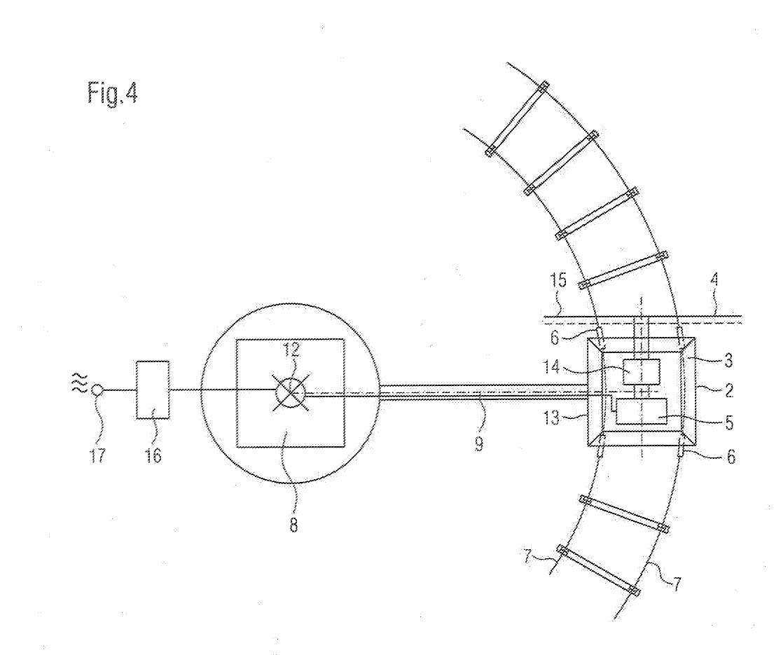

A drive for the chassis 2 may be provided, for example by means of a motor coupled thereto or by means of a boom 9 coupled to a motor 8 that is centrally situated within a circular rail track. If desired, chassis 2 (and wind turbine 4 mounted thereto) may be mounted to a nacelle 13 which is, in turn, mounted via wheels 6 to rails 7 and connected voa boom 9 to motor 8 around a vertical axis 12, such that nacelle 13 moves eccentrically around axis 12, see FIG. 4.

Instead of a motor 8, it is also possible to provide some other type of drive, for example a convection turbine having a vertical axis, so that use may be made of ascending heated air as drive energy in order to increase the incident flow velocity, in particular when there is little or no air flow.

One advantage of the invention is that the wind turbine 4 together with the chassis 2 may be moved backwards along the rails 7 when the wind is too strong, so that the incident flow velocity is virtually reduced. When the wind speed decreases, the chassis 2 together with the wind turbine 4 may then be moved forward once again, thus virtually increasing the incident flow velocity. Overall, a relatively constant virtual incident flow velocity may thus be achieved.

In the drawing, the wind turbine 4 is situated eccentrically with respect to the chassis 2, i.e., not above the center of gravity of the chassis. However, this may be modified within the scope of another arrangement, in particular in such a way that the center of gravity of the overall arrangement made up of the chassis 2, framework 3, wind turbine 4, and electric generator 5 is situated approximately in the center of the area spanned by the four wheels 6, thus minimizing the risk of tipping.

Tipping of the chassis 2 together with its superstructures may also be counteracted by the rails 7 having not only an upper running track, but also a lower running track, which is engaged from below by suitably guided wheels 6.

FIG. 4, which is a more detailed view of FIG. 1, there can be seen that rails 7 are mounted via ties or sleepers on top of a flat elevated structure, the top side of which is in the paper plane. The rail track 7 follows a circular path around a center 12.

Furthermore, FIG. 4 shows a nacelle 13 (i) mounted via wheels 6 to the guiding rail tracks 7 and (ii) via a cantilever 9 to a vertical axis in the center 12. The cantilever 9 can be driven by a motor 8 around the vertical axis in the center 12, so that the nacelle 13 moves eccentrically around the axis in the center point 12.

The wind wheel 4 comprises several blades 15. Behind and parallel to the plane of the blades 15 of the wind wheel, there can be seen a lamella-like curtain as a broken line. By shutting this lamella-like curtain, an adverse wind can be prevented from decelerating the wind wheel 4.

Furthermore, FIG. 4 discloses that a free-wheel 14 is arranged between the axis of the wind wheel 4 and the generator 5. The free-wheel 14 is mounted in such rotational relationship that the axle coupled to the wind wheel 4 cannot rotate faster than the axle coupled to the generator, but the axle coupled to the generator can rotate faster than the axle coupled to the wind wheel. Due to such measure, even an adverse wind decelerates the wind wheel 4, it cannot decelerate the rotational speed of the generator 5.

The electric energy produced by the generator 5 is fed through one or more cables in or along the cantilever beam 9 to the central point 12, where it can be picked off via collector rings and fed to an accumulator and/or to a device 16 for feeding the obtained electrical energy as a current into a power grid 17.

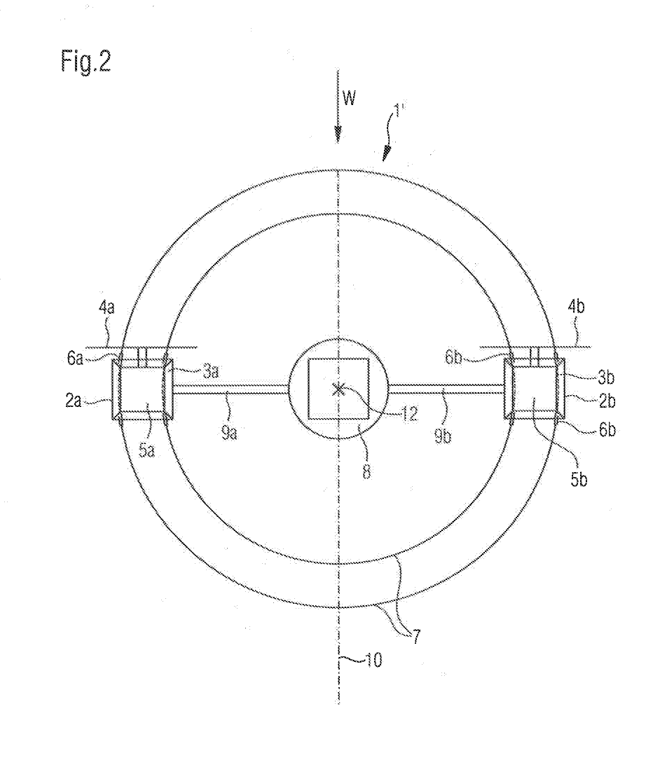

FIG. 2 shows a refinement of the arrangement according to FIG. 1. Two chassis 2a, 2b are hereby provided in each case, each bearing one wind turbine 4a, 4b and one electric generator 5a, 5b, respectively. The arrangement is mirror-symmetrical with respect to an axis of symmetry 10 that passes exactly between the two chassis 2a, 2b.

Optimal incident flow by the wind is provided when the wind direction is parallel to the axis of symmetry 10. The flow conditions are then also symmetrical with respect to one another with good approximation, as are the forces acting on the two wind turbines 4a, 4b. These forces are thus evenly balanced.

Since the two chassis 2a, 2b are rigidly connected to one another by the booms 9a, 9b, the chassis always assume diametrically opposed positions with respect to one another along the circular rail track 7, relative to the midpoint thereof, where the central motor 8 is situated.

The overall arrangement made up of the chassis 2a, 2b and booms 9a, 9b is intrinsically rigid, and therefore can at best oscillate back and forth about a central axis, with the two chassis 2a, 2b traveling along the rails 7. Use may be made of this characteristic for an automatic orientation of the two wind turbines 4a, 4b with regard to the incident wind or air flow.

This may be achieved, among other ways, in that the setting angles of the blades of the particular wind turbine 4a, 4b, which is situated on the particular front chassis 2a, 2b with respect to the wind, are set to be flatter, i.e., in a plane transverse to the instantaneous wind direction. The surface area of this wind turbine 4a, 4b exposed to the wind thus increases, resulting in a torque that once again pushes the wind turbine 4a, 4b in question backwards, while the other wind turbine 4b, 4a then once again moves forward along the circular path 7. The force or drive energy required for this purpose is supplied by the wind.

Moreover, doubling or quadrupling the number of wind turbines 4a, 4b naturally results in a corresponding increase in the power conversion.

Whereas for the wind power plant 1′ according to FIG. 2, the overall arrangement is usually in equilibrium and therefore always undergoes only small compensating movements, the wind power plant 1″ is optimized for circulating operation at a rotational speed D, in particular also with an incident wind W.

Thus, since the overall arrangement made up of the wind turbines 4a, 4b, chassis 2a, 2b, and booms 9a, 9b rotates about the midpoint of the circular rail track 7, one of the two wind turbines 4a, 4b always faces the wind W, whereas the respective other wind turbine faces away at exactly the same point in time, i.e., is acted on by incident wind from behind, which would decelerate the rotation of this wind turbine 4a, 4b.

Such a disadvantageous effect may be avoided, for example, by a freewheel being situated in each case between a wind turbine 4a, 4b and the associated electric generator 6a, 6b, the freewheel transmitting only driving torques in the usual rotational direction, but not decelerating torques. See FIG. 4.

To avoid deceleration of a wind turbine 4a, 4b, in addition, one lamella-like curtain 11a, 11b may be provided in the area of each respective chassis 2a, 2b, in close proximity behind a wind turbine 4a, 4b.

The lamella-like curtains 11a, 11b are designed in such a way that an incident wind acting on the wind turbine 4a, 4b in question from the front can deflect the lamellae, which are pivotable about their longitudinal edges, preferably about their upper longitudinal edges, backwards, i.e., in the wind direction W. The lamellae thus pivot out of a shared plane and orient in parallel to one another, resulting in a large interspace between adjacent lamellae which allows the wind to pass through essentially unhindered.

However, if the wind direction W is from the opposite direction, the lamellae are prevented from correspondingly pivoting away in the other direction by means of stop elements. The lamellae thus remain in a shared plane, the lamella curtain remains closed, and the wind cannot pass through up to the wind turbine 4a, 4b in question, and thus also cannot decelerate the wind turbine.

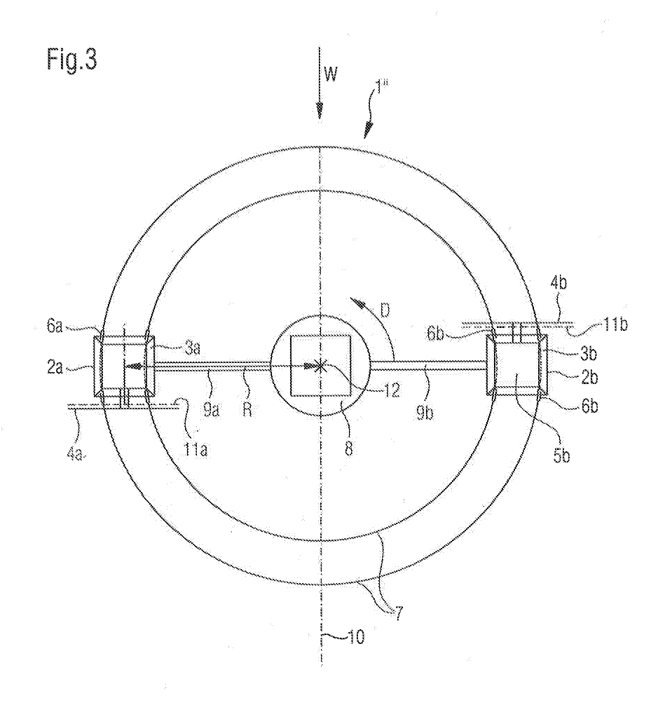

At the same time, the back-pressure of the wind W acting on the closed lamella curtain delivers a torque which drives the overall arrangement made up of the chassis 2a, 2b, wind turbines 4a, 4b, and electric generators 6a, 6b in the direction of circulation, and which drives the respective front wind turbine 4a, 4b against the wind, so that in the position shown in FIG. 3, a maximum virtual flow S results that is given by

S=W+D*2πR,

where R stands for the average distance of a wind turbine 4a, 4b from the midpoint 12 of the circular rail track 7.

While the summand D*2πR remains approximately constant, regardless of the particular position of the chassis 2a, 2b in question, the influence of the summand W depends on the instantaneous position of the wind turbine 4a, eb ab [sic; 4a, 4b] in question, for example according to a sine or cosine function, resulting in incident flow approximately as follows:

S=W*sin α+D*2πR,

where α is the angle of revolution, relative to a zero point on the leg of the axis of symmetry 10 facing away from the wind W.

A freewheel, described above, as well as the lamella curtain 11a, 11b also described above, prevent a decelerating effect, in particular if the factor sin α is less than zero. In this case, the following always applies:

S>D*2πR,

since W*sin α is canceled out for values less than zero. The lamella curtain 11a, which is situated to the left of the line of symmetry 10 in each case in FIG. 3 and is closed, delivers the driving torque, and captures the incident air and distributes it to both wind turbines 4a, 4b via the booms 9a, 9b.

This higher virtual flow S results in a higher rotational speed of the wind turbine 4a, 4b, resulting, among other things, in easier start-up of the system. In addition to the foregoing, it should also be appreciated that, if desired, wind power plant 1 may comprise a device 16 for feeding obtained electrical energy as current into a power grid (see FIG. 4).

In another, alternative embodiment, the wind power plant 1 may have a miniaturized design and may be situated onboard a vehicle 18 that is suitable for roadway travel, so that this vehicle 18 is able to generate current from its kinetic energy, for example during a braking operation. For this purpose, such a wind power plant 1⁽³⁾ is preferably situated within the vehicle body 25, for example beneath the hood, and when necessary may be switched on as soon as excess kinetic energy is available, such as during a braking operation or during downhill travel. For this purpose, the wind turbine may be concealed behind a streamlined cowling which may be opened as needed, but which is closed during acceleration operations so as not to generate air resistance.

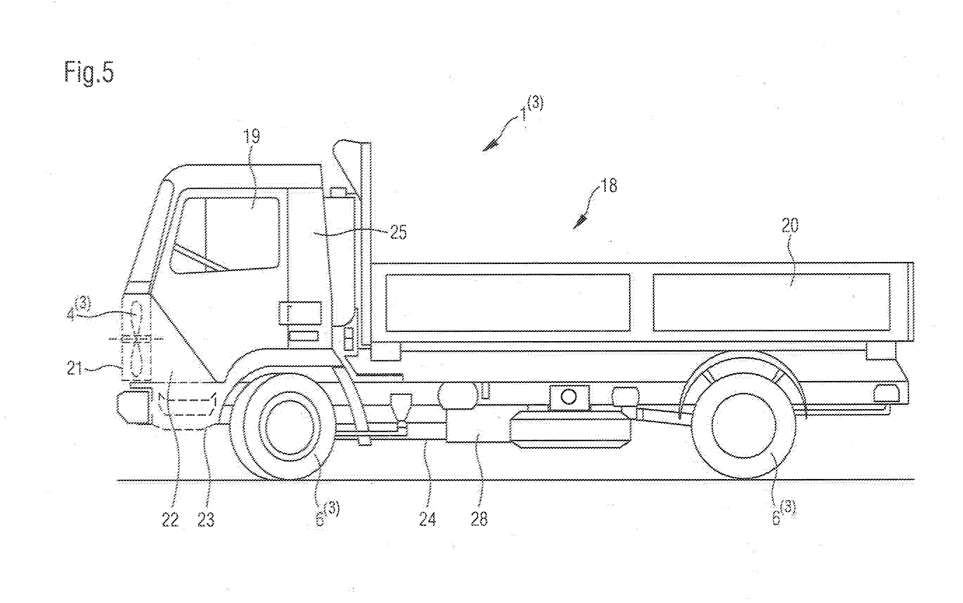

The wind power plant 1⁽³⁾ according to FIG. 5 is designed as a road vehicle or motor vehicle 18, for example as a transport vehicle like a lorry or motortruck with a driver's cabin 19 and a cargo area or load area 20. Other embodiments of such vehicle 18 are possible, for example as a passenger car or as a coach or bus.

In such vehicle 18, the wind wheel 4 may be installed behind the grill 21 in the front of the vehicle 18, with the rotational axis of the wind wheel 4 oriented in a horizontal direction, especially along the direction of travel of the vehicle 18. As can be seen from FIG. 5, there should be provided an air passage or ventilation duct 22 behind the wind wheel 4 to allow the inflow wind to leave the car body or the engine compartment after rotationalle driving the wind wheel 4.

If the downstream mouth 23 of such air passage or ventilation duct 22 is at the bottom side 24 underneath the car body 25, where during movement of the vehicle 18 the pressure is below the atmospheric pressure, the pressure difference between inflowing air and outflowing air can be used to optimize the energy yield. The pressure is particularly low in the area of a diffusor at the underside 24 of a vehicle 18.

The generated electric energy can be stored within an energy storage 28, specifically can be used to charge an accumulator on board of the vehicle 18. On the other hand, the energy storage 28 could be designed as a tank for storing hydrogen gas generated from water by electrolysis in an electrolytic cell onboard of the vehicle 18.

If the vehicle 18 comprises an electric drive motor, the additional electric energy can be used to extend the range of the vehicle 18 of one charge cycle. In case of a storage tank 28 for hydrogen gas, there could be provided a fuel cell onboard of the vehicle 18 for generating a current from the stored hydrogen gas to drive the vehicle 18.

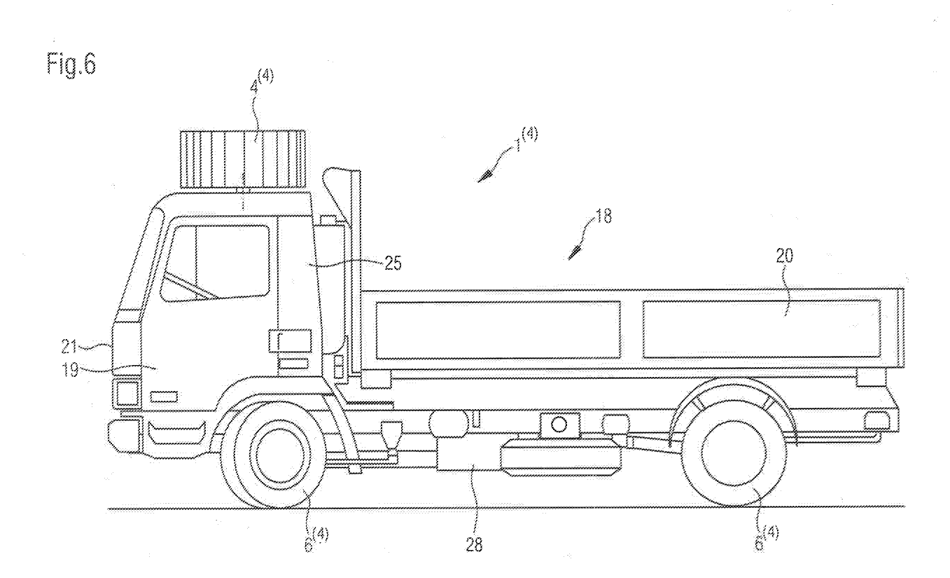

The wind power plant 1⁽⁴⁾ according to FIG. 6 is designed as a road vehicle or motor vehicle 18⁽⁴⁾, too. As a difference to the road vehicle or motor vehicle 18⁽⁴⁾, the wind wheel 4⁽⁴⁾ is not installed behind the grill 21 in the front of the vehicle 18⁽⁴⁾, but on top of the driver's cabin 19 of the vehicle 18⁽⁴⁾, and the axis of rotation 26 of the wind wheel 4⁽⁴⁾ is not oriented in a horizontal direction, but in a vertical direction.

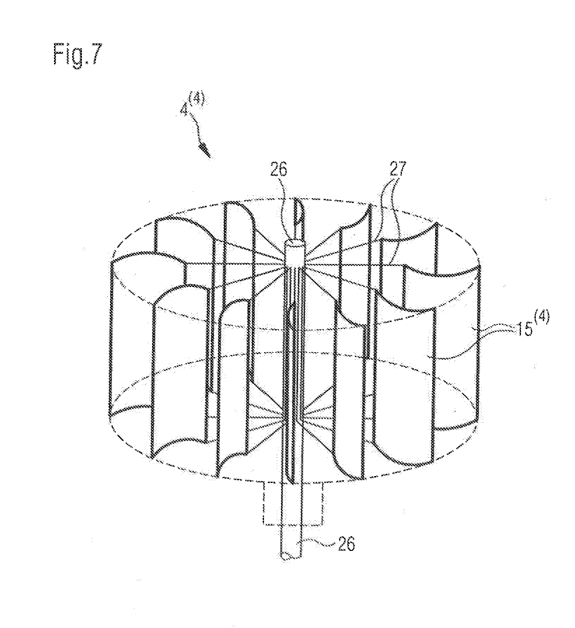

Such wind wheel 4⁽⁴⁾ itself Is shown in more detail in FIG. 7. It comprises beams 27 extending from the axis of rotation 26 radially outwards like radial spokes, especially in two planes above each other. The free ends of two such spokes or radial beams 27 of different planes each support a blade 15⁽⁴⁾ of the wind wheel 4⁽⁴⁾, and these blades 15⁽⁴⁾ have a curved cross section, so that an inflowing wind generates a higher pressure at the concave main surface of such blade 15⁽⁴⁾ than at its convex main surface.

Therefore, even if all blades 15⁽⁴⁾ of such wind wheel 4⁽⁴⁾ receive the same airstram, the pressure on such blades 15⁽⁴⁾ whose concave main surfaces face the airstram will be higher than the pressure on such blades 15⁽⁴⁾ whose convex main surfaces face the airstram, and the wind wheel 4⁽⁴⁾ will rotate in a direction where the convex main surfaces face into the direction of rotation, and the concave main surfaces will face against such direction of rotation.

For a wind wheel 4⁽⁴⁾ with a vertical axis of rotation 26, the direction of the inflowing air is not relevant. Therefore, even if the vehicle 18⁽⁴⁾ does not move, in case of a sufficient wind strength the wind wheel 4⁽⁴⁾ will generate rotational energy at its axis or rotation 26, which can be converted into alectrical energy within a generator 5 coupled to the axis of rotation 26. For this purpose, the generator 5 can be installed at the top of the driver's cabin 19, either inside or outside.

The generated electric energy can be stored within an energy storage 28, specifically can be used to charge an accumulator on board of the vehicle 18⁽⁴⁾. On the other hand, the energy storage 28 could be designed as a tank for storing hydrogen gas generated from water by electrolysis via an electrolytic cell onboard of the vehicle 18⁽⁴⁾.

If the vehicle 18⁽⁴⁾ comprises an electric drive motor, the additional electric energy can be used to extend the range of the vehicle 18⁽⁴⁾ of one charge cycle. In case of a storage tank 28 for hydrogen gas, there could be provided a fuel cell onboard of the vehicle 18⁽⁴⁾ for generating a current from the stored hydrogen gas to drive the vehicle 18⁽⁴⁾.

At a bus, several such wind wheels 4⁽⁴⁾ may be installed behind each other along the direction of travel to generate a multiplicity of energy compared to only one wind wheel 4⁽⁴⁾.

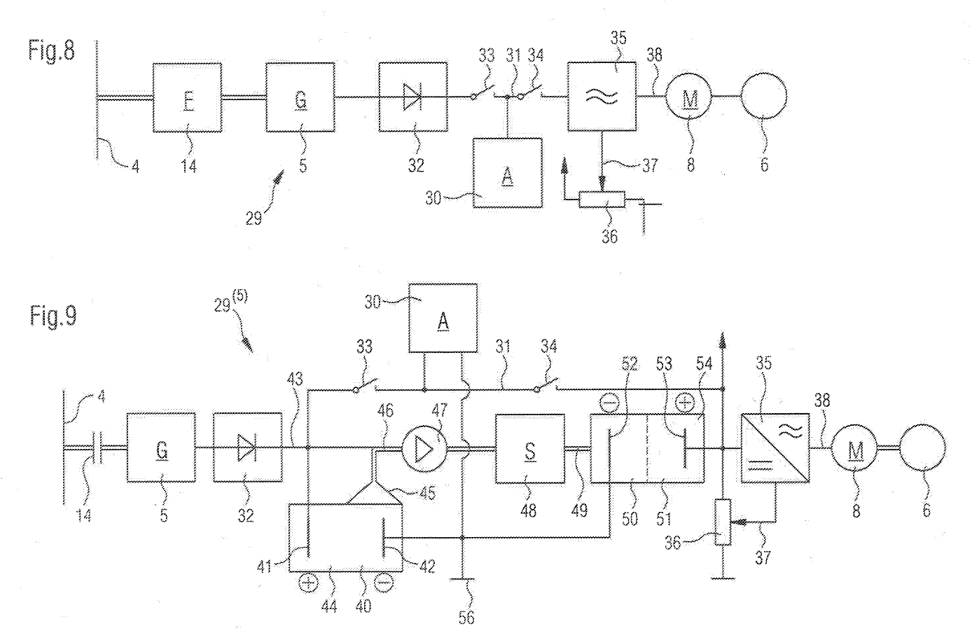

FIG. 8 discloses an example for the electric circuitry 29 of a wind turbine 1 according to anyone of the aforementioned embodiments.

A central component of this cicuitry 29 is an energy storage 28 in the form of an accumulator 30. The electric terminals 31 of such accumulator 30 can be coupled either to the regarding wind wheel 4 via—if necessary—a free-wheel 14, via the generator 5 and—if necessary, that is if the generator 5 does not generate a direct current at its output—via a rectifier 32 for converting an alternating current or a sinusoidal output voltage of the generator 5 into a direct current for charging the accumulator 30, if the switch 33 is closed, or, if switch 34 is closed, to at least one wheel 6 driven by a motor 8 via—if necessary, that is if the motor 8 is no direct current motor—an inverter 35 with an input where a potentiometer 36 can be connected for inputting a control voltage into the inverter 35 as a signal representing an acceleration command.

The potentiometer 36 can be mechanically connected to an acceleration pedal which is operated by a driver of the vehicle 18, for example in such way that an increasing control voltage 37 leads to an increased mean value of output current or output voltage 38 of the inverter 35, so as to control the torque and/or speed of the motor 8.

In special cases where a recuperation of energy from the wheels 6 of a vehicle 18 is desired in case of a braking operation, the inverter 35 may comprise a second input where another potentiometer can be connected for inputting a second control voltage into the inverter 35 as a signal representing a deceleration command, and then the inverter 35 reduces its output voltage so that the motor 8 is operated as a generator and takes mechanical energy from the wheels 6 in order to brake the vehicle 18 while this energy is used to charge the accumulator 30.

The electric circuitry 29⁽⁵⁾ disclosed in FIG. 9 is amended over the circuitry 29 of FIG. 8 by an additional block 39 comprising several additional components which can be used to assist the accumulator 30 in storing energy. This can be considered as a measure to (virtually) enhance the charging capacity of the accumulator 30⁽⁵⁾ far beyond the charging capacity of the accumulator 30 in FIG. 8.

The additional block 39 comprises an electrolyse cell 40 with an anode 41 and a cathode 42, wherein preferably the anode 41 is connected to the output 43 of the rectifier 32 or—if the generator 5 is a direct current generator—directly to the output of the generator 5, while the cathode is connected to a common ground 56. The electrolyse cell 40 is a bassin 44 filled with distilled water, into which the anode 41 and the cathode 42 are submerged. During opertion of the electrolyse cell 40, oxygen bubbles are generated at the anode 41 and hydrogen bubbles at the cathode 42.

Such hydrogen bubbles are collected by a hood 45 which is located above the cathode 42. This hood 45 has an output at the elevated center of the hood 45, so that the hydrogen which is lighter than air is collected and fed to a duct 46 connected to that output

That duct 46 leads to a compressor 47 which feeds the compressed hydrogen gas to a pressure vessel 48 where the hydrogen can be stored, for example at a pressure of up to 200 bar.

In case energy is needed to drive one or more wheels 6 via the motor 8, hydrogen gas is fed via a duct 49 from an output of the pressure vessel 48 to a compartment 50 of a fuel cell 51, especially to a compartment 50 comprising an anode 52.

A cathode 53 is placed within a cathode compartment 54, and a membrane 55 is arranged between both compartments 50, 53. While the cathode 53 is connected to common ground 56, the anode 52 is or can be coupled to the input of the inverter 35.

If necessary, several electrolyse cells 40 may be connected in series, if the voltage at the output 43 of the generator 5 or rectifier 32 is substantially higher than the voltage at one electrolyse cell 40. On the other hand, several fuel cells 51 may be connected in series, if the voltage at one fuel cell 51 is substantially lower than the input voltage needed by the inverter 35.

List of reference numerals

| | |
|---|---|
| 1 | wind power plant |
| 2 | chassis |
| 3 | framework |
| 4 | wind turbine |
| 5 | electric generator |
| 6 | wheels |
| 7 | rails |
| 8 | motor |
| 9 | boom |
| 10 | axis of symmetry |
| 11 | lamella curtain |
| 12 | midpoint |
| 13 | nacelle |
| 14 | Free-wheel |
| 15 | blade |
| 16 | device |
| 17 | power grid |
| 18 | vehicle |
| 19 | driver's cabin |
| 20 | load area |
| 21 | grill |
| 22 | ventillation duct |
| 23 | downstream mouth |
| 24 | bottom side |
| 25 | car body |
| 26 | axis of rotation |
| 27 | radial beam |
| 28 | energy storage |
| 29 | electric circuitry |
| 30 | accumulator |
| 31 | Electrical terminal |
| 32 | Rectifier |
| 33 | Switch |
| 34 | switch |
| 35 | inverter |
| 36 | potentiometer |
| 37 | control voltage |
| 38 | output voltage |
| 39 | additional block |
| 40 | electrolyse cell |
| 41 | anode |
| 42 | cathode |
| 43 | output |
| 44 | bassin |
| 45 | hood |
| 46 | duct |
| 47 | compressor |
| 48 | pressure vessel |
| 49 | duct |
| 50 | compartment |
| 51 | fuel cell |
| 52 | anode |
| 53 | cathode |
| 54 | compartmend |
| 55 | membrane |
| 56 | common ground |

1. A wind generator, comprising:
at least one wind wheel which is mounted to be rotatable around a rotational axis, and which has one or more blades or other wind-guiding surfaces for converting flow energy of wind into rotational energy,
at least one generator, which is coupled to a hub or shaft of the wind wheel or to an output shaft of a gear connected thereto, for converting the rotational energy into electrical energy,
wherein a center of gravity of the wind wheel, together with a hub and rotor shaft and rotatable parts which are coupled to the hub or rotor shaft and rotate around the same rotational axis, is translationally movable in a horizontal or approximately horizontal direction
characterized in that:
the generator is either a direct current generator or is on its output side coupled to a rectifier to provide the electrical energy as direct current,
at least one energy storage is coupled to a direct current output of the generator or of the rectifier for receiving and storing the electrical energy.

2. The wind generator according to claim 1, characterized in that the at least one energy storage is translationally movable in a horizontal or approximately horizontal direction.

3. The wind generator according to claim 1, characterized in that the at least one energy storage is mounted in such way that a center of gravity of the energy storage is translationally movable in the same direction and with the same speed as the center of gravity of the wind wheel.

4. The wind generator according to claim 1, characterized in that the at least one energy storage is a static storage for storing the fed electrical energy permanently.

5. The wind generator according to claim 1, characterized in that the at least one energy storage comprises at least one capacitor for storing the fed electrical energy electrically, especially in the form of an electrical field.

6. The wind generator according to claim 1, characterized in that the at least one energy storage comprises at least one accumulator for storing the fed electrical energy electrochemically.

7. The wind generator according to claim 6, characterized in that the at least one energy storage comprises at least one lithium ion accumulator.

8. The wind generator according to claim 1, characterized in that the at least one energy storage comprises at least one apparatus for storing the fed electrical energy chemically.

9. The wind generator according to claim 8, characterized in that at least one apparatus for storing the fed electrical energy chemically comprises at least one electrolytic cell, especially an electrolytic cell for the fission of water into oxygen an hydrogen.

10. The wind generator according to claim 9, characterized in that at least one apparatus for storing the fed electrical energy chemically comprises at least one storage tank for storing the electrolytically generated hydrogen.

11. The wind generator according to claim 1, characterized in that the rectifier is a bridge rectifier.

12. The wind generator according to claim 1, characterized in that the translational movement of the wind generator is guided in parallel to a surface area of a subsurface, in particular guided in parallel to a preferably horizontal plane.

13. The wind generator according to claim 1, characterized in that a wind resistance of the wind wheel or of parts thereof is adjustable, in particular in that a setting angle of one or several blades or other wind-guiding surfaces is changeable, or in that the wind turbine is pivotable with respect to an incident flow direction.

14. The wind generator according to claim 1, characterized in that the wind generator has a mobile design, in particular by means of bottom-side wheels.

15. The wind generator according to claim 14, characterized in that the wind generator and/or the wind wheel are/is situated on a chassis or onboard a vehicle or a nacelle.

16. The wind generator according to claim 15, characterized in that the chassis or vehicle can travel on rails.

17. The wind generator according to claim 16, characterized in that the rails are laid in a circle.

18. The wind generator according to claim 17, characterized by a tower or some other elevated structure, to which the rails are mounted.

19. The wind generator according to claim 14, characterized in that the wind generator or its wind wheel or both are/is not coupled in terms of rotational movement to one of the bottom-side wheels.

20. The wind generator according to claim 15, characterized in that a nacelle is mounted to be pivotable around a vertical pivot axis.

21. The wind generator according to claim 20, characterized in that the nacelle is mounted to be pivotable along a circular path around a vertical pivot axis, wherein the rotational axis of the wind wheel is oriented tangentially with respect to the circular path described by the nacelle.

22. The wind generator according to claim 15, characterized by a device for driving the vehicle or the chassis or the nacelle in a translational motion.

23. The wind generator according to claim 22, characterized in that the drive device is designed as an internal combustion engine, or as at least one electric motor.

24. The wind generator according to claim 23, characterized in that an electric output of the at least one energy storage is electrically connected to the electric input of the at least one electric motor.

25. The wind generator according to claim 24, characterized in that the electric motor comprises at least one three-phase synchronous or asynchronous motor.

26. The wind generator according to claim 25, characterized in that at least one three-phase inverter is interconnected between the electric output of the at least one energy storage and the three-phase synchronous or asynchronous motor.

27. The wind generator according to claim 26, characterized in that a three-phase output of the at least one three-phase inverter is switchable between the at least one three-phase synchronous or asynchronous motor, and an alternating current output of the generator.

28. The wind generator according to claim 26, characterized in that a three-phase output of the at least one three-phase inverter is switchable to an output connector for exchanging electric energy between the energy storage and an external energy grid.

29. The wind generator according to claim 25, characterized by a control device for switching the three-phase output of the at least one three-phase inverter either to an at least one three-phase synchronous or asynchronous motor, or to an alternating current output of the generator, or to an output connector for exchanging electric energy between the energy storage and an external energy grid.

30. The wind generator according to claim 6, characterized in that an electric input and an electric output of a capacitor or accumulator are conductively connected to each other.

31. The wind generator according to claim 10, characterized in that at least one storage tank for storing electrolytically generated hydrogen comprises an outlet duct which is coupled to a fuel cell.

32. The wind generator according to claim 31, characterized in that the fuel cell is designed to transform chemically stored energy of electrolytically generated hydrogen into electrical energy.

33. The wind generator according to claim 31, characterized in that the fuel cell comprises an electric output where direct current is provided.

34. The wind generator according to claim 22, characterized in that a projection of a center of gravity of the device for driving the chassis or the vehicle or the nacelle in a translational motion along a circular path is situated within a circle described by the vehicle or chassis or the nacelle during its movement.

35. The wind generator according to claim 22, characterized in that a projection of a center of gravity of the device for driving the vehicle or chassis onto a subsurface guiding the vehicle in a translational motion is situated outside a polygon, which is spanned by the contact areas of the bottom-side wheels on the subsurface.

36. The wind generator according to claim 15, characterized in that a projection of a center of gravity of the wind wheel or wind generator onto a subsurface guiding the vehicle is situated within a polygon, which is spanned by the contact areas of the bottom-side wheels on the subsurface.

37. The wind generator according to claim 1, characterized in that the wind wheel is not surrounded by wind deflector plates.

38. The wind generator according to claim 15, characterized in that a diameter of the wind wheel is greater than the largest width of the vehicle or chassis, in particular greater than a lateral distance between two bottom-side wheels thereof on different sides of the vehicle or chassis.

39. The wind generator according to claim 15, characterized in that a plurality of more than the single chassis or of more than the single nacelle are guided at the same time on a guide device.

40. The wind generator according to claim 39, characterized in that a plurality of more than the single chassis or of more than the single nacelle guided on the same guide device are connected or coupled to one another in order to undergo synchronous movements.

41. The wind generator according to claim 40, characterized in that sides of a plurality of wind wheels, which are acted on by incident wind (W) on a plurality of more than the single chassis or of more than the single nacelle, point in local directions corresponding to a same movement direction of connecting means.

42. The wind generator according to claim 40, characterized in that sides of a plurality of wind wheels, which are acted on by incident wind (W) on a plurality of more than the single chassis or of more than the single nacelle, point in local directions corresponding to opposite movement directions of connecting means.

43. The wind generator according to claim 1, characterized in that the blades of the at least one wind wheel are adjustable about a longitudinal axis of the regarding blade in order to be adaptable to different relative speeds of incident air.

44. The wind generator according to claim 43, characterized in that the blades of the at least one wind wheel are continuously adjustable, i.e., adjustable over arbitrary, unlimited setting angles, in order to be adaptable to a reversal of the direction of relative rotation with respect to the incident air.

45. The wind generator according to claim 1, characterized by a regulation which always orients two or more of the at least one, mutually connected wind wheels against the wind (W), in that the setting angle of the blades of the wind wheel in front with regard to the particular incident flow direction is in each case adjusted in such a way that a wind resistance of this wind wheel is increased, and is thus reduced by incident wind (W).

46. The wind generator according to claim 1, characterized by a device for feeding obtained electrical energy as current into a power grid or into an alternating current power grid or or into a three-phase power grid.

47. The wind generator according to claim 46, characterized by a device for synchronizing the current, to be fed, with a frequency of a voltage in the alternating current power grid or three-phase power grid.

48. The wind generator according to claim 1, characterized in that a freewheel is situated between a wind turbine and the electric generator associated therewith, so that in the event of a countergust, the electric generator, despite the decelerated wind turbine, can continue to rotate freely in a practically undecelerated manner.

49. The wind generator according to claim 1, characterized in that a device for deflecting countergusts or other types of air flow that are unfavorable for the normal rotational direction of the wind wheel is provided at the wind wheel, preferably upstream or downstream therefrom.

50. The wind generator according to claim 49, characterized in that the device for deflecting countergusts or other types of air flow that are unfavorable for the normal rotational direction of the wind turbine is designed as a lamella-like curtain whose lamellae are open for a normal incident flow direction of the air, but closed for the opposite incident flow direction of the air.

51. The wind generator according to claim 1, characterized in that the rotational axis of the at least one wind wheel extends in a vertical direction.

52. The wind generator according to claim 1, characterized in that the at least one wind wheel converts flow energy of wind into rotational energy independent of the flow direction of the wind.

53. The wind generator according to claim 1, characterized in that the at least one wind wheel is designed to convert flow energy of the air stream of the translational moving wind generator into rotational energy independent of the translational moving direction of the wind generator.

54. The wind generator according to claim 22, characterized in that the vehicle is designed to transport people and/or goods.

55. The wind generator according to claim 22, characterized in that the vehicle is a motorbus or a motorcar or a motortruck.
